(19) United States
(12) Patent Application Publication
(10) Pub. No.: US 2024/0281818 A1
(43) Pub. Date: Aug. 22, 2024

(54) SYSTEM AND METHOD FOR PREDICTING FRAUD AND PROVIDING ACTIONS USING MACHINE LEARNING

(71) Applicant: THE TORONTO-DOMINION BANK, TORONTO (CA)

(72) Inventors: KEYVAN GOLESTAN IRANI, NEWMARKET (CA); XIAO SHI HUANG, TORONTO (CA); MARIE-CHRISTINE DOUCAS, MONTREAL (CA); DALIA FARAG, POINTE-CLAIRE (CA); JEAN-CHRISTOPHE BOUËTTÉ, MONTREAL (CA)

(21) Appl. No.: 18/444,560

(22) Filed: Feb. 16, 2024

Related U.S. Application Data
(60) Provisional application No. 63/446,777, filed on Feb. 17, 2023.

(51) Int. Cl. G06Q 20/40; G06N 20/20

(52) U.S. Cl. CPC G06Q 20/4016; G06N 20/20

(57) ABSTRACT

The disclosed method and system provide an unsupervised machine learning model, specifically an isolation forest model, to identify potential fraudulent activity in policies communicated within a distributed computing system. This model is trained and fine-tuned using tabular data, including social graph connectivity features, with a training dataset containing unlabelled data and a tuning dataset comprising labelled instances of fraudulent activity. Through iterative tuning, the model adjusts its features (e.g. model splitting thresholds) to optimize detection accuracy, ensuring that anomalies predicted by the model align with labelled fraudulent policies in the tuning dataset. Subsequently, computerized actions are triggered based on the model's predictions to manage displaying, routing and processing the policy to one or more other computing devices for action based on the prediction within the distributed computing system.

### CROSS-REFERENCE TO RELATED APPLICATION

This application claims the benefit of U.S. Provisional Patent Application No. 63/446,777, filed Feb. 17, 2023, and entitled “System and Method of Anomaly Detection and Action Using Predictive Modelling”, the entire contents of which is incorporated by reference herein in its entirety.

### FIELD

The present disclosure generally relates to a system and method for extracting insights from input data via a predictive machine learning model for automatically predicting whether a target policy may be fraudulent and for triggering based on such predictions, computerized actions, operations and/or notification alerts on related computing device(s).

### BACKGROUND

Underwriting fraud is a scourge for service providers in the fields of finance, data security and insurance, among others. Instances typically occur when users furnish service providers with false or erroneous information during the online bind process for the purposes of securing favourable policy terms and activating policies. Thus, service providers require systems and methods for verifying the accuracy of information received from customers and a need to do so in real time or as near real time as possible. One of the current methods for detecting underwriting fraud is by manually screening policies for fraudulent information patterns; however, insurance binding channels are expanding and this option is not feasible in big data environment where large numbers of policies are transacted on a daily basis. Additionally, manually screening is not only labour intensive, but is error prone and unable to handle large amounts of data or detect patterns in such large data and is certainly unable to do so in real time. Also, given the variety of data sources available in an underwriting system, manual screening does not enable consideration of the variety of data or its interrelationships. Additionally, any defined rule based systems may be limiting and outdated based on out of date information.

When purchasing insurance online, fraudsters continually change patterns in fraudulent transactions and policy information provided making fraud prediction a difficult task. Due to the large number of daily insurance policy transactions that typically occur, it is impractical for service providers to screen policies retroactively for fraudulent information patterns. Additionally, as insurance binding channels continue to evolve, so too do fraudulent information patterns, making manual screening a time consuming and error prone process.

There is thus a need for an adaptable and dynamic predictive machine learning model for detecting potentially fraudulent insurance policies (e.g. purchased online) by uncovering electronic fraudulent information patterns in large amounts of data transacted over a network in a real time manner.

### SUMMARY

A system of one or more computers can be configured to perform particular operations or actions by virtue of having software, firmware, hardware, or a combination installed on the system that in operation causes or cause the system to perform the actions. One or more computer programs can be configured to perform particular operations or actions by virtue of including instructions that, when executed by a data processing apparatus, cause the apparatus to perform the actions.

In one general aspect, there is provided a computer implemented system comprising: a communication interface; a memory storing instructions; one or more processors coupled to the communication interface and to the memory, the one or more processors configured to execute the instructions to perform operations comprising: obtaining, from a database, first information comprising tabular features identifying prior instances of policies for at least one product transacted with a merchant entity; obtaining, from the database, second information comprising social connection features identifying relationships between components of the policies for the at least one product and overlapping values for the components; concatenating the first and second information into a tabular format to form a model generation data set; splitting the model generation data set into a training data set and a tuning data set based on whether a data sample is labelled for fraudulent activity based on the prior instances, wherein the tuning data set comprises labelled data for fraudulent activity; applying the training data set, in a training phase, having unlabelled data to a tree classifier network for training an unsupervised isolation forest model for anomaly detection by generating an ensemble of decision trees, each decision tree setting different splitting conditions based on an unsupervised learning of the training data and providing an initial output indicative of a probability of anomaly for a given input and generating an output of the unsupervised isolation forest model during training based on a weighted combination of the initial output from each decision tree, the output indicative of a total probability of anomaly; applying the tuning data set in a tuning phase, having the labelled data indicative of fraudulent activity, to tune the trained model by applying the tuning data set to the trained model to detect a set of anomalies corresponding to the tuning data set, the anomalies having the total probability generated from the ensemble of decision trees higher than a defined threshold, determining whether the set of anomalies detected corresponds to the labelled data indicative of fraudulent activity and responsive to a difference between the set of anomalies detected and the labelled data, modifying features of the trained model iteratively by retuning the model until the set of anomalies detected corresponds to the labelled data to generate a tuned model that indicates a likelihood of fraudulent activity based on the anomalies detected; applying a first data set having a first feature set associated with a new policy from a requesting device received via the communication interface for the entity to the tuned model to determine, based on the output of the isolation forest model previously tuned, the probability of fraudulent activity as a weighted combination of outputs from each of the ensemble of decision trees from the tuned model; and, responsive to determining the probability of fraudulent activity for the first data set exceeding a first threshold, displaying the probability and the new policy associated therewith on a graphical user interface and routing the first data set to a second computing device via the communication interface, across a communication network, for flagging and denying processing of the new policy and notifying the requesting device.

In a further aspect, the processor is further configured to perform operations, comprising: responsive to determining the probability of fraudulent activity for the first data set is below the first threshold, displaying the probability on the graphical user interface and routing the first data set to the second computing device via the communication interface for allowing processing the new policy and notifying the requesting device.

In a further aspect, operations of the processor for retuning the model comprise: determining a defined set of top contributing features for all input features in the model generation data set contributing to the detection of a particular anomaly not corresponding to and thereby not indicative of fraudulent activity based on the labelled data in the tuning data set; removing the set of top contributing features in the tuning data set and the training data set to bias the model to consider other features in an updated feature set; and iteratively retraining and retuning the model based on the updated feature set indicative of fraudulent activity to generate an updated model for subsequent incoming policies.

In a further aspect, operations of the processor for determining the defined set of top contributing features contributing to the detection comprises applying depth based isolation forest feature importance (DIFFI) to generate DIFFI values providing a measure of feature contribution of each feature for all the input features in the model generation data set to splitting and isolation of anomalous cases in the generated ensemble of decision trees by the unsupervised isolation forest model trained and applying the feature contribution to remove features with DIFFI values below a selected threshold and repeating iteratively training and tuning of the model based on remaining features to determine the selected threshold to provide a desired feature set having an improved correlation between anomaly detection as compared to an indication of fraudulent activity in the labelled data compared to a prior iteration of the model.

In a further aspect, operations of the processor further comprise rendering the likelihood of fraudulent activity and the measure of feature contribution provided via DIFFI values for each feature of a set of input features for the new policy contributing to anomaly detection prediction, as interactive interface elements on the graphical user interface.

In a further aspect, operations of the processor further comprise receiving additional features or updated features for the model generation data set in a subsequent model iteration and removing features one at a time in each iteration of model training and model tuning to compare performance change relative to the labelled data during the tuning phase to determine an optimal set of features for generating the unsupervised isolation forest model.

In a further aspect, operations of the processor further comprise applying a plurality of data sets for new policies associated with the merchant entity to the tuned model and determining a ranked list of each of the new policies based on the likelihood of fraudulent activity determined from the tuned model, and operations further comprise: rendering the ranked list as interactive interface elements on the graphical user interface for receiving input accepting or denying each policy, and operations of the processor further configured to feed back the input to retrain and retune the isolation forest model.

In a further aspect, the tuning data set comprises a set of labelled fraudulent policies interspersed with a set of labelled non-fraudulent policies.

In a further aspect, the training data set comprises unlabelled fraudulent and non-fraudulent policies.

In a further aspect, identifying relationships comprises operations of the processor to generate a social network graph of connectivity between components of the policies comprising policy information, policy holder information, identification information for the at least one product, and social entities along with associated values for the components, wherein graph links are connected between a set of nodes relating to a set of policies sharing a same component value.

In yet another aspect, there is provided a computer implemented method comprising: obtaining, using at least one processor of a computing device and from a database, first information comprising tabular features identifying prior instances of policies for at least one product transacted with a merchant entity; obtaining, using the at least one processor, from the database, second information comprising social connection features identifying relationships between components of the policies for the at least one product and overlapping values for the components; concatenating, using the at least one processor and the first and second information, into a tabular format to form a model generation data set; splitting, using the at least one processor, the model generation data set into a training data set and a tuning data set based on whether a data sample is labelled for fraudulent activity based on the prior instances, wherein the tuning data set comprises labelled data for fraudulent activity; applying, using the at least one processor, the training data set in a training phase, having unlabelled data, to a tree classifier network for training an unsupervised isolation forest model for anomaly detection by generating an ensemble of decision trees, each decision tree setting different splitting conditions based on an unsupervised learning of the training data and providing an initial output indicative of a probability of anomaly for a given input and generating an output of the unsupervised isolation forest model during training based on a weighted combination of the initial output from each decision tree, the output indicative of a total probability of anomaly; applying, using the at least one processor, the tuning data set in a tuning phase, having the labelled data indicative of fraudulent activity, to tune the trained model by applying, using the at least one processor, the tuning data set to the trained model to detect a set of anomalies corresponding to each sample of the tuning data set, the anomalies having the total probability generated from the ensemble of decision trees higher than a defined threshold, determining whether the set of anomalies detected corresponds to the labelled data indicative of fraudulent activity and responsive to a difference between the set of anomalies detected and the labelled data, modifying features of the trained model iteratively by retuning the model until the set of anomalies detected corresponds to the labelled data to generate a tuned model that indicates a likelihood of fraudulent activity based on the anomalies detected; applying, using the at least one processor, a first data set having a first feature set associated with a new policy from a requesting device received via a communication interface for the entity to the tuned model to determine, based on the output of the isolation forest model previously tuned, the probability of fraudulent activity as a weighted combination of outputs from each of the ensemble of decision trees from the tuned model; and, responsive to determining, using the at least one processor, the probability of fraudulent activity for the first data set exceeding a first threshold, displaying the probability and the new policy associated therewith on a graphical user interface of the computing device and routing the first data set to a second computing device via the communication interface, across a communication network, for flagging and denying processing of the new policy and notifying the requesting device.

Other embodiments of this aspect include corresponding computer systems, apparatus, and computer programs recorded on one or more computer storage devices, each configured to perform the actions of the methods.

### BRIEF DESCRIPTION OF THE DRAWINGS

These and other features of the disclosure will become more apparent from the following description in which reference is made to the appended drawings wherein:

FIG. 1 is a diagram of an exemplary computing environment for predicting a likelihood of online fraudulent activity in electronic policies transacted using unsupervised machine learning and notifying associated computing entities in accordance with one or more embodiments.

FIG. 2 is a diagram of an exemplary computing system, a model system of FIG. 1 in accordance with one or more embodiments.

FIG. 3 is an example process performed by the model system of FIGS. 1 and 2 for generating model input data for an unsupervised machine learning model in accordance with one or more embodiments.

FIG. 4 is an example process performed by the model system of FIGS. 1 and 2 for training the unsupervised machine learning model to generate an output prediction identifying and notifying of likelihood fraudulent activity, in accordance with one or more embodiments.

FIG. 5 is an example process performed by the model system of FIGS. 1 and 2 for tuning the unsupervised machine learning model and rendering an explainability of the model output, in accordance with one or more embodiments.

FIG. 6 is a flowchart illustrating example operations of a computing device, e.g. the model system of FIGS. 1 and 2, in accordance with one or more embodiments.

### DETAILED DESCRIPTION

Generally, in at least some embodiments, this disclosure relates to a system and method for extracting insights from large amounts of data (e.g. big data analytics) transferred between computing devices such as policy applications and policy related information (e.g. policy identification, product identification, merchant information for the policy, contact information of users associated with policy, demographic profile of policy holders, policy application details, etc.) via an unsupervised predictive machine learning model for automatically determining in real time whether a target application may contain fraudulent information patterns for triggering further computing actions, e.g. further analytics for processing the policy, approving or denying the policy to be held with a merchant, displaying analytics relating to the fraud prediction on a graphical user interface with interactive components for approving or denying the prediction to improve the model, or alerts to one or more related policy computing devices relating to the prediction, etc.

As will be described herein, one of the technical problems in devising a machine learning model or other model to accurately and dynamically predict fraudulent activity in data transacted (e.g. policy data) is the challenges in the datasets being analyzed. These data limitations include but are not limited to: a lack of data, both in total volume of historical instances of policy data as well as in amount of labelled data indicating whether each policy and associated features are fraudulent or not; a lack of policy data for model training in online binding environment; and a lack of accuracy in manually labelled policy data sets with labels relating to fraudulent activity as well as a lack of diversity in the labelled dataset. These data challenges may lead to computing challenges in accurately predicting fraudulent activity.

As will be described, in one or more embodiments, by applying unsupervised machine learning prediction systems to diverse policy data sets having different format types and limited labelled data sets for machine learning training, using an unsupervised isolation forest model specifically configured to handle the limitations of the data and selecting an optimal model from tuning the model by using performance metrics on a small available labelled data set, the system allows optimization of such models for identifying fraudulent policy activities.

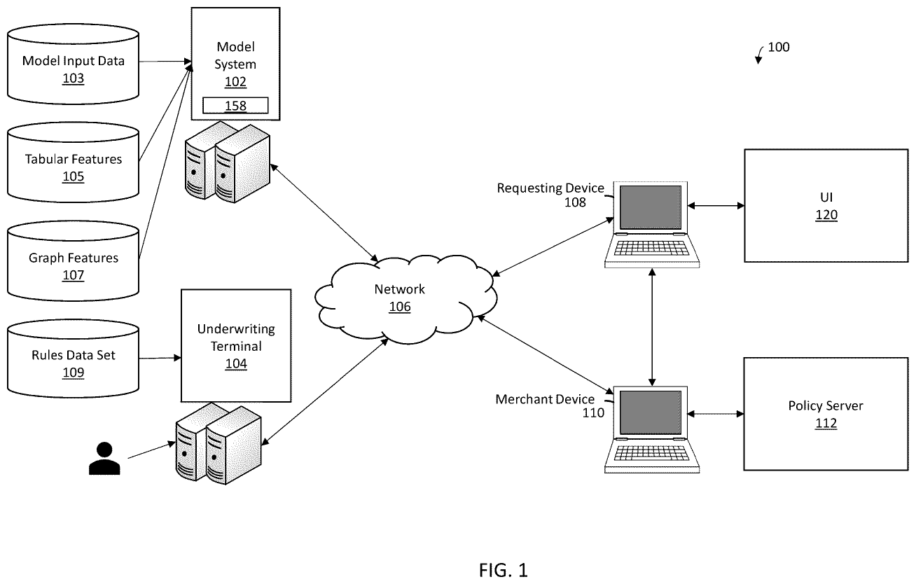

FIG. 1 illustrates an exemplary computing environment 100 in accordance with one or more embodiments. As illustrated in FIG. 1, in one aspect, the computing environment may include a model system 102, an underwriting terminal 104, a requesting device 108 (also may be referred to as a client device) having a client user interface (UI) 120, and a merchant device 110 having a policy server 112.

Referring again to FIG. 1, the model system 102 may be configured to use machine learning prediction models and specifically unsupervised machine learning models using tree classifiers to uncover patterns in data transacted across the computing environment 100, such as in underwriting policies that will potentially be used for fraudulent policies and thus be able to in real time notify one or more associated computing devices, such as the underwriting terminal 104 and/or policy server 112 of policies with highest likelihood of suspicious or fraudulent activity, render a display of such likelihood on one or more associated computing devices, e.g. a user interface of the model system 102, and cause the policy to be approved or denied (e.g. on the policy server 112) based on the likelihood of fraudulent activity detected by the model system 102. For example, the policy server 112 may deny policies having a high likelihood of fraudulent activity; approve others with a low likelihood of fraudulent activity while other policies that may be close to a defined threshold may be routed, in some aspects, by the model system 102 to the underwriting terminal 104 for further analysis and investigation, such as for applying a set of defined rules to confirm or deny the results.

The model system 102 may include a core machine learning model or models designed to analyze and predict fraudulent underwriting policies as described herein and utilize unsupervised machine learning models to handle the data limitations of the training/tuning data sets as well as the diversity in the data types which may be received. In one embodiment, the model system 102 may be one or more computer systems configured to process and store information and execute software instructions to perform one or more processes consistent with the disclosed embodiments. In certain embodiments, the model system 102 may include one or more servers and one or more data storages such as model input data 103, tabular data or tabular features 105, graph features 107 (containing connectivity data between policies, policy holders, policy features and feature values which may be converted to a connectivity graph of edges and nodes defining connection between them).

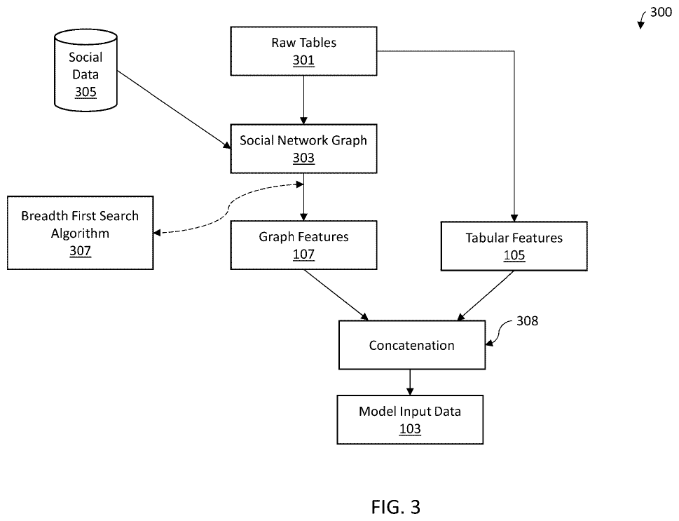

The model system 102 includes unsupervised machine learning models, such as isolation forest tree models as illustrated in FIGS. 3-5 that facilitate the learning and inference tasks related to identifying fraudulent patterns within electronic transactions such as policy application or underwriting policies.

The underwriting terminal 104 may serve as a computerized interface or platform utilized by underwriters to input, access, and review underwriting policies such as by applying a defined set of rules shown as rules data set 109 to determine whether or not there is fraudulent activity. Such labelled and/or unlabelled policy data from underwriting terminals 104 and/or policy server 112 defining historical instances of prior fraudulent activities relating to policies may be provided to the model system 102 for training, tuning and/or generating the machine learning models to predict a likelihood a policy contains fraudulent activity and thus should be denied or further investigated or the likelihood a policy does not contain fraudulent activity and thus should be approved such as via policy server 112. Thus, the underwriting terminals 104 may provide functionalities for data entry, policy examination and decision-making support, and such historical policy data may be fed to the model system across a communication network 106 to generate and/or tune the unsupervised machine learning models.

In one aspect, the requesting device 108 may act as an intermediary or endpoint through which requests for predictions or analyses of underwriting policies are initiated. Alternatively, the requesting device 108 may be the device which contains a new policy to be examined for fraudulent activity and computerized action determination based on being fed to the model system 102 for detecting fraudulent activity patterns. Requests from the requesting device 108, such as for new policies, may be initiated via a client application, a web service, or any other electronic communication mechanism such as via input on the client user interface 120 through which users or systems interact with the machine learning system of the model system 102.

In one aspect, the merchant device 110 represents the point of interaction with merchants or entities involved in the underwriting process. The merchant device 110 may be a server, a computing terminal, a software application, or any other interface through which merchant-related policy data is collected, processed, and potentially utilized for fraud prediction. The merchant device 110 may further represent the merchant from which a policy application is made via a requesting device 108 which may be stored on a policy server 112 and, in the case of new incoming policy data (e.g. after the model is trained), fed to the model system 102 for prediction and action.

The merchant device 110 further comprises a policy server 112 which functions as a central repository where underwriting policies, merchant data, and relevant information are stored, managed, and accessed. The policy server 112 may facilitate policy data retrieval, storage, and communication between different components of the environment 100, ensuring seamless interaction and integration for fraud prediction purposes.

Thus, in one or more aspects, the model system 102 may be configured to estimate, based on applying a particularly configured machine learning model, a likelihood a policy (e.g. as requested from a requesting device 108 via communications with a merchant device 110 and associated policy server 112 containing policies) is an underwriting fraud and should be flagged for either denying the policy and/or further investigation such as routing to the underwriting terminal 104 (e.g. for applying rules data set 109).

In one or more aspects, the policy data communicated in the environment 100 comprises a variety of data sources available including tabular features 105 and graph features 107 or social-connection features extracted from a graph network by the model system 102 as will be described with reference to FIG. 3. In one aspect, tabular features 105 are built out of the raw fields. For example, tabular features 105 may be extracted from a source database, e.g. raw tables 301, for a variety of product policy types (e.g. home and auto) and merged into a single unified table for model ingestion. In another aspect, the model system applies breadth first search algorithm 307 as illustrated in FIG. 3 to extract features out of each graph. The model system 102 is then configured to derive model features by concatenating together the tabular 105 and graph features 107 and passing them to a tree classifier model, namely an unsupervised tree classification model applying isolation forest algorithm, which is designed for training decision tree classifiers that perform unsupervised anomaly detection. It is easily scalable to large datasets and achieves state-of-the-art performance in the domain of unsupervised anomaly detection.

Such unsupervised anomaly detection, rather than applying a supervised classification model, allows handling of the data limitations such as the labelled data shortage and/or diversity of detected patterns.

In one or more aspects, the model system 102, upon flagging certain policies as having a high potential for underwriting fraud, is configured to then route the flagged policies to the underwriting terminal 104 and/or policy server 112 for further computerized action (e.g. denial of policy, notification of associated policy terminals, and/or application of rules data set 109 to the flagged policies to determine whether the certain policies are also flagged by the rules data set).

Advantageously, in at least some aspects, the computing environment 100 allows customers to request to purchase, in real time, an auto or home policy online (e.g. via a merchant device computer application or underwriting application or merchant policy application or via a web browser from the requesting device 108) without human or manual intervention. To reduce computing network security risk of such fraudulent policies, the model system 102 is configured to flag and action problematic policies via unsupervised machine learning. For example, approving fraudulent underwriting policies may involve the processing and storage of sensitive personal and transaction data. The approval of fraudulent policies increases the likelihood of sensitive data exposure and computing system compromise. Fraudulent policies introduce operational disruptions and compromise the integrity of the underwriting system. Malicious entities associated with the fraudulent policies may exploit vulnerabilities to disrupt operations, manipulate data, or gain unauthorized control over critical system components. Thus, there is a need for a computing system, as provided by the model system 102 which accurately and in real time predicts a likelihood a policy is an underwriting fraud and trigger automatic and dynamically generated actions (e.g. denying policies identified as likely fraudulent or routing to other computing devices in the distributed system) to handle the policies being communicated across the network 106.

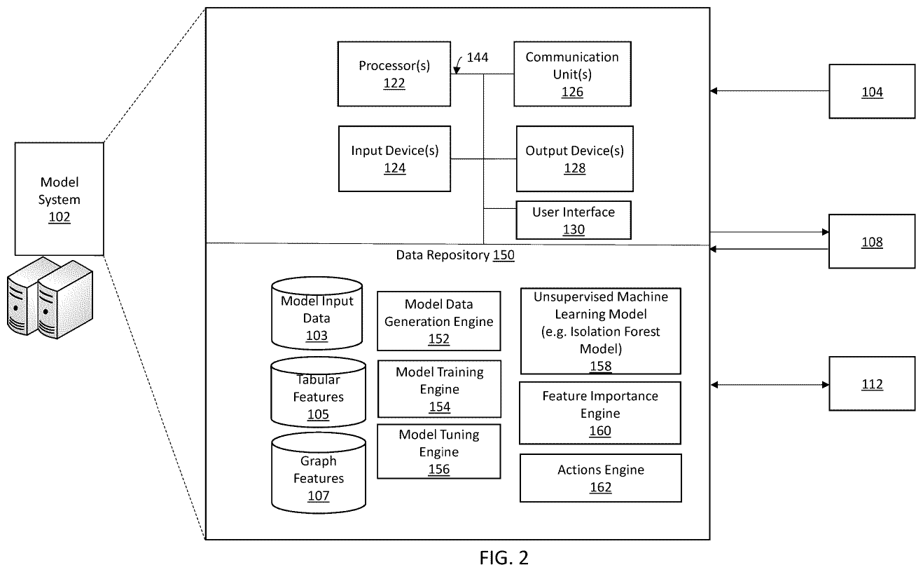

Referring to FIG. 2, shown is an example computer system, e.g. model system 102, with which embodiments consistent with the present disclosure may be implemented. The model system 102 includes at least one processor 122 (such as a microprocessor) which controls the operation of the computer. The processor 122 is coupled to a plurality of data storage components and computing components via a communication bus or channel, shown as the communication channel 144.

The model system 102 further comprises one or more input devices 124, one or more communication units 126 or communication interfaces such as for communicating with underwriting terminal 104, requesting device 108 and merchant device 110, one or more output devices 128, a user interface 130, and one or more isolation forest models as may be generated via an unsupervised machine learning model 158. Model system 102 also includes one or more data repositories 150 storing one or more computing modules and components such as model data generation engine 152, model training engine 154, model tuning engine 156, unsupervised machine learning model 158, feature importance engine 160, actions engine 162, model input data 103, tabular features 105, and graph features 107.

Communication channels 144 may couple each of the components for inter-component communications whether communicatively, physically and/or operatively. In some examples, communication channels 144 may include a system bus, a network connection, an inter-process communication data structure, or any other method for communicating data.

Referring to FIGS. 1 and 2, one or more processors 122 may implement functionality and/or execute instructions as provided in the current disclosure within the model system 102. The processor 122 is coupled to a plurality of computing components via the communication bus or communication channel 144 which provides a communication path between the components and the processor(s) 122. For example, processors 122 may be configured to receive instructions and/or data from storage devices, e.g. data repository 150, to execute the functionality of the modules shown in FIG. 2, including the unsupervised machine learning model 158 among others (e.g. operating system, applications, etc.).

Model system 102 may store data/information as described herein for the process of generating a plurality of unsupervised machine learning models 158, e.g. isolation forest models 403 as described with reference to FIGS. 3-5 specifically trained, tuned and generated for mapping anomalies within the isolation forest models 403 to a likelihood of fraud detection in policy data particularly in limited training data having a majority of unlabelled data and small subset of labelled data being applied for evaluation by the isolation forest model 403 to ensure that the anomalies correctly align with the fraud prediction in the policies. Upon positive determination, the processor may be configured in at least some aspects to perform actions via the actions engine 162 such as notifying affected devices across the communication unit 126, displaying the prediction on associated user interfaces such as user interface 130 and routing the policies to one or more relevant devices in the computing environment 100 of FIG. 1 for further analysis and review such as underwriter terminal 104, policy server 112, etc. Some of the functionality is described further herein.

One or more communication units 126 may communicate with external devices such as data sources, underwriting terminals 104, requesting device 108, merchant device 110, and policy server 112, via one or more networks (e.g. communication network 106) by transmitting and/or receiving network signals on the one or more networks. The communication units 126 may include various antennae and/or network interface cards, etc. for wireless and/or wired communications.

Input devices 124 and output devices 128 may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. 144).

The one or more data repositories 150 may store instructions and/or data for processing during operation of the policy processing system. The one or more storage devices may take different forms and/or configurations, for example, as short-term memory or long-term memory. Data repositories 150 may be configured for short-term storage of information as volatile memory, which does not retain stored contents when power is removed. Volatile memory examples include random access memory (RAM), dynamic random access memory (DRAM), static random access memory (SRAM), etc. Data repositories 150, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

Operations and additional components of the model data generation engine 152, the model training engine 154, the model tuning engine 156, the unsupervised machine learning model 158, the feature importance engine 160 and the actions engine 162 are further discussed with reference to FIGS. 3-6, in accordance with one or more embodiments.

### Model Data Generation Engine 152

Referring to FIGS. 1-3, the model system 102 may comprise a model data generation engine 152 for obtaining, processing, formatting and generating model input data obtained from a variety of data sources (e.g. generating model input data 103 from tabular features 105, graph features 107 and/or other policy related data features) communicated across the environment 100 of FIG. 1 into a desired format for training, tuning and generating a prediction model, such as an unsupervised machine learning model 158 (e.g. an isolation forest model).

FIG. 3 illustrates an exemplary process 300 and components for generating model input data, such as via the model data generation engine 152 of FIG. 2 to be ingested by the unsupervised machine learning model 158 for generating and tuning the model for identification, notification and subsequent action based on the resultant output when considering new policies received.

In one embodiment, process 300 may be performed by model system 102 and more particularly, at least the model data generation engine 152 of FIG. 2 in cooperation with other computing components.

FIG. 3 illustrates, in at least one aspect, how data may be extracted and preprocessed for model input. In one aspect, in process 300, tabular data (e.g. client related policy data) is combined with social network information (graph information indicating connectivity between policy components) for the model generation.

As illustrated, raw tables 301 are ingested from one or more databases. Each single data input may include but is not limited to: policy purchases (e.g. policy number, name, credit card), client information at onset policy purchase (e.g. insurance policy), merchant or entity identification with which a policy is held, etc. For example, raw tables 301 may relate to policy information extracted from a policy server 112 and historical policies held, an underwriting terminal 104 which may include some labelled data as to flagging for fraudulent activities (e.g. based on applying rules data set 109) and such data may be partial or incomplete or inaccurate and/or policy input data received directly from the requesting device 108 when completing a policy application such as policy holder identification.

Although certain aspects of the disclosed embodiments are described in connection with a financial entity or merchant and insurance policies, the disclosed embodiments are not so limited and may be applied to other types of transactions and may be associated with a merchant that provides accounts online for other types of online transactions whereby there is limited or no labelled data for training and/or low quality or low volume of useful training data and/or diversity of data types (e.g. tabular, graph, etc.) of transactions being processed and/or variety of relationships between components of the input data such that the proposed unsupervised machine learning model using isolation forest modelling configured in a particular manner to be trained and tuned iteratively to utilize the data limitations advantageously and generate a model that can accurately and in real time enable prediction, flagging and action of fraudulent activity in transactions, such as those received on a requesting device 108 to a merchant device 110.

Referring to FIGS. 1-3, in process 300, other than tabular features 105 data extracted from raw business tables shown as raw tables 301, the model system 102 generates a graph to link different social entities (including but not limited to policy numbers, VINs, emails, names, phone numbers) into a social network graph 303, from which connectivity features may be extracted as shown as graph features 107. The model system 102, and particularly model data generation engine 152 may extract features out of the network via a Breadth First Search (BFS) algorithm 307 which respects the temporal component on the creation of the edges.

In one aspect and referring to FIGS. 1-3, tabular features 105 and graph features 107 may be concatenated, via concatenation 308, by the model system 102 before passing as model input data 103 to an unsupervised anomaly detection model, e.g. isolation forest model as may be generated by the unsupervised machine learning model 158 of FIG. 2. The model may ingest both table features for training as well as inference.

Tabular features 105 may, in some aspects, comprise data extracted from raw fields (i.e., policy application inputs), and graph features 107 may represent information extracted from a social network graph 303. In at least one aspect, applicants may populate raw fields whilst completing online policy applications via the client UI 120. Additionally, a social network graph 303 may be generated by the model system 102 with information (e.g., names, addresses, phone numbers, contact information) traversed from multiple databases, e.g. social data 305. Social connection features may be sourced from social network graphs 303 via a breadth first search algorithm 307.

In at least one aspect, the social network graph 303 may be created, by the model system 102 using available contact information, collected from separate databases in the form of multiple contact tables such as social data 305, then consolidated into one single file for ingestion by the model training procedure. Features may include but are not limited to: contact information related to auto/home policies (name, email, phone, address, VIN, policy number) and billing information (bank account number or confounded payment credit card number & names). Using this information and at least one processor 122, the model system 102 creates a social network graph 303 which reflects the connection between policies, individuals, and social entities retrieved from input data. For example, in the social network graph 303, links (graph edges) between policies (one type of graph node) and product IDs (another type of graph node) may be created by matching policies that share the same product ID. The social network graph 303 may then be traversed by a Breadth First Search algorithm 307 to output the final features used for model training, shown as model input data 103 (as combined with tabular features 105). An example of a graph feature in the graph features 107 may be the average number of connections or graph edges for all graph nodes in the neighborhood of the policy in question.

### Model Input Data 103

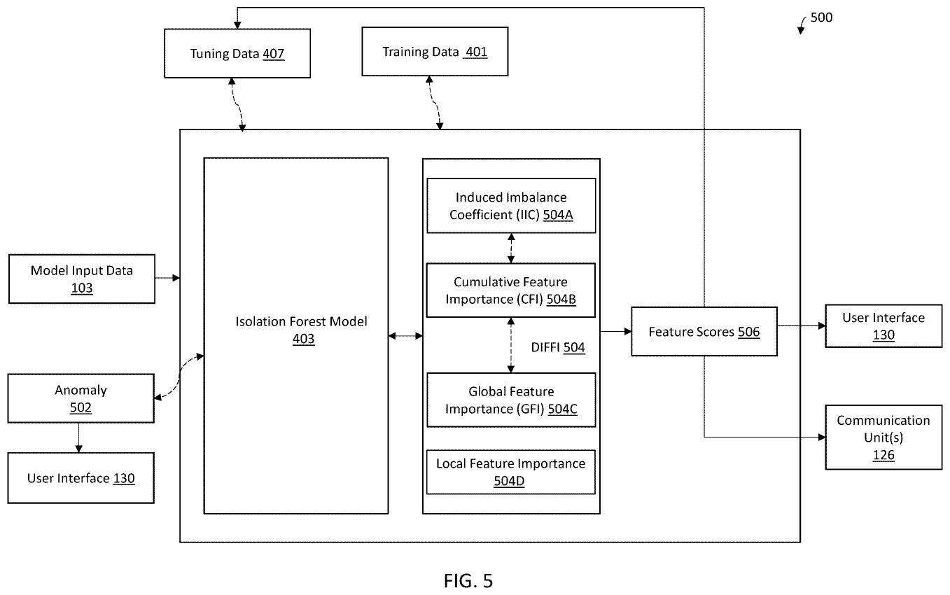

In at least some example interactions and referring to FIGS. 1-5, model input data 103 may consist of tabular features 105 extracted from input data as well as social-connection features or graph features 107 sourced from a graph network. The machine learning prediction model for the model system 102 uses an unsupervised machine learning model 158 as shown in FIG. 2 that is trained to detect anomalies in the input data such as the policy application data. Using a model-specific explainability method tailored for isolation forest model 403 (see FIG. 5), which determines feature contribution, the features fed into a given model may be revised and the model retuned and retrained to optimize predictions. In some aspects, the model 403 may then be configured to assign scores to different features of the input data based on the feature importance, shown as feature scores 506.

In some aspects, the results of the prediction performed by the model system 102 may provide a likelihood of acceptance of a target application for further review and/or analysis by associated computing devices of the environment 100.

### Training a Machine Learning Model-Model Training Engine 154

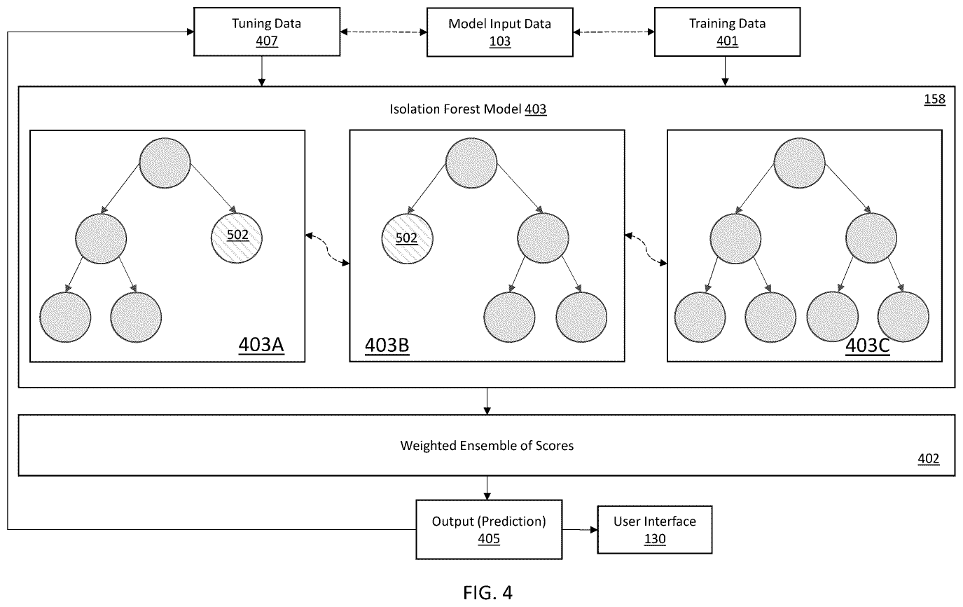

Referring to FIG. 4 and with reference to FIGS. 1-3, in at least some aspects, shown is an exemplary process for the model system 102 in generating (e.g. via the model training engine 154 and/or model tuning engine 156) an unsupervised anomaly detection model shown as the unsupervised machine learning model 158 that does not rely upon labelled data for training the model and is mapped to a different context via iterative retraining and tuning phases and/or feature importance contribution application to generate a model able to proactively detect fraudulent information activity pattern in input data.

In at least some aspects, the unsupervised model uses an unsupervised anomaly detection classifier, notably isolation forest model 403 to detect fraudulent information activity patterns in input data according to training on model input data 103 including tabular 105 and graph features 107.

Taking into consideration some of the technical challenges including but not limited to the lack of model data (both labelled and unlabelled), the limitations of rules data set 109 used at underwriter terminals 104 to provide the labels (e.g. of whether or not fraudulent activity detected on a policy), the fact that detected underwriting fraud policies by underwriter terminals typically represent a small percentage of all fraud patterns and thus making it desirable to discover more diverse, undetected and unlabelled cases, the model selected for the prediction in the model system 102 is the isolation forest algorithm for underwriting fraud detection. As will be described, an isolation forest algorithm is an unsupervised algorithm for training an anomaly detection decision tree classifier and is easily scalable to large datasets and achieving accurate performance in the domain of unsupervised anomaly detection. Additionally, the isolation forest model as applied herein allows examination of the raw data and does not require labelled data. However, as will be described herein, the anomaly detection performed by the model does not necessarily imply fraudulent activity prediction for transactions. That is, while fraudulent policies may be anomalies in the transaction data, not all anomalies located by the unsupervised anomaly detection model (e.g. isolation forest model) may be indicative of fraud. Thus, as described herein, the model system 102 applies additional tuning with the small set of labelled data and retrains the model as differences arise. The model system 102 may further, in some aspects, apply an explainability tool such as a feature importance tool (e.g. depth based isolation forest feature importance or DIFFI also shown as the feature importance engine 160 in FIG. 2) to further determine which features contributed to an erroneous detection during the tuning phase of the machine learning model and remove/modify those features for subsequent iterations of the model training/tuning until an optimized model is generated (e.g. see FIGS. 4 and 5). DIFFI is a global interpretability method which may be applied by model system 102 to provide Global Feature Importances (GFIs) representing a condensed measure describing the macro-behavior of the isolation forest model on training data.

Referring again to FIG. 4, the model system 102 may be configured to execute instructions, such as via model training engine 154 to generate an unsupervised anomaly detection tree classifier such an isolation forest model 403, by applying training data 401 (e.g. containing unlabelled data). The isolation forest model 403 comprises an ensemble of multiple independent isolation decision trees (shown as iTrees 403A, 403B and 403C in FIG. 4) that classify features into different groups for the purposes of identifying anomalies. Each decision tree is configured to have different splitting conditions and therefore makes different judgements on the same sample. The final model output (e.g. output prediction 405) is a learned weighted combination of the results from all trees in the tree set, e.g. iTrees 403A-403C. For example, each decision tree is configured to assign a score to particular groups of features representing the model's confidence that an anomaly is present. Individual decision tree scores are then aggregated in order to determine how likely it is that input data contains fraudulent information. Isolation forest model 403 may randomly pick a feature for every split, and hence, the number of times a feature appears in the trees can vary.

From a high level, the isolation forest model 403 is trained such that individual trees (e.g. iTrees 403A-403C) are built, each of which predicts a score on any sample fed to it, by passing the sample down a binary decision tree until it lands on a leaf node; the prediction output 405 of the model is a weighted ensemble of all scores 402 from all the trees in the model. The isolation forest model 403 of the model system 102 as generated may operate as follows: 1) it does not require a label on the samples; 2) it does not require backpropagation of error signals to adjust tree splitting thresholds; 3) model outputs the anomaly score, or a measure of the degree of isolation, of input samples, instead of its positive probability. In the training phase of the isolation forest model 403, iTrees 403A-403C are constructed by recursively partitioning the given training set until instances are isolated or a specific tree height is reached of which results a partial model.

Put another way, the isolation forest model 403 may be trained as follows: (a) for each isolation tree, randomly select a feature from the input dataset, such as training data 401, (b) randomly choose a split value for partitioning the data along the selected feature whereby the random partitioning produces shorter paths for anomalies, and (c) recursively partition the data until each data point is isolated or a predefined maximum depth is reached.

Next, the isolation forest model 403 may be configured, by at least one processor 122 of the model system 102 to assign an anomaly score to each data point based on its average path length within the isolation trees and compute the average path length for each data point across all isolation trees. Since shorter average path lengths indicate that a data point is more easily isolated and thus highly likely to be an anomaly, the isolation forest model 403 may assign scores accordingly.

In one or more aspects, the model 403 builds an ensemble of isolation trees by repeating the tree construction process using different subsets of the dataset and ensures diversity in the trees by varying the subsets and the features selected for partitioning.

As shown in FIG. 4, a weighted ensemble of scores 402 is then calculated to aggregate the anomaly scores obtained from individual trees to generate a final anomaly score for each data point.

Based on the final anomaly score, the model outputs a prediction 405 to identify data points with higher scores as potential anomalies. The model system 102 may threshold the anomaly scores to distinguish between normal and anomalous observations within the dataset.

As shown in FIG. 4, in one or more aspects, the output prediction 405 may also be fedback to the model parameters, e.g. tuning data 407 to utilize in a subsequent iteration for tuning the trained model (e.g. using the small subset of labelled data), isolation forest model 403 and triggering retraining as necessary.

Referring again to FIG. 4, the output from the isolation forest model 403 output on any input sample is a model confidence score or metric that such sample is considered to be an anomaly, compared with the training samples. Here, anomaly may be defined by the model 403 as any sample that may easily be isolated from the rest of the sample population by a few binary classification rules (feature value greater than or smaller than a certain threshold value); the fewer decisions it takes, the higher the degree of isolation the sample possesses. Conveniently, the isolation forest model 403 does not require labels on the input samples during training (e.g. training data 401).

Conveniently, in at least some aspects, the isolation forest model 403 as trained by the model system 102 alleviates limitations of the data sets being analyzed such as but not limited to: handling of lack of data (e.g. limited underwriting fraud data as well as lack of investigated and positive policies or labelled data which may result in a skewed dataset distribution and in other models may further exaggerate the lack of data); inaccurate labelled policies as positive or negative case; diversity in the underwriting fraud data set (which cannot be captured by rules data sets).

As noted earlier, in one or more aspects, the training data 401 defining the training set consists mainly or completely of unscreened policies (e.g. no indication whether the policy was screened negative or positive with relation to flagging for fraud), leading to a heavily skewed dataset in terms of labels; but since the isolation forest model 403 applied by the model system 102 is an unsupervised model that is designed for anomaly detection, such skewed distribution does not affect the model.

In one or more aspects, as described herein, the model system 102 may assign (e.g. via the model data generation engine 152), the model input data 103 to training data 401 and tuning data 407 respectively for isolation forest model 403 training and tuning. That is, labelled data indicative of fraudulent activity in the policy data features may be dedicated in at least some aspects to tuning data 407 for model evaluation while unlabelled data (e.g. not screened data) may be assigned to training data 401 as isolation forest model 403 training does not rely on labelling to train the model.

Put another way, in one or more implementations, the unsupervised machine learning model 158 is trained without a target definition (e.g. training data 401); rather, labels of fraudulent activity such as accepting a policy for further investigation (e.g. screened positive or screened negative) is used in the model tuning stage (e.g. tuning data 407 used by model tuning engine 156) for feature selection and performance estimation, which has no bias towards any segments in the portfolio (the target and therefore the model looks equally at all regions).

An example of the training policies distribution which may be used in the training data 401 containing at least a large majority of unlabelled data (or fully unlabelled data) may be seen in Table 1 below.

TABLE 1
Training Policies Distribution

| MAIN CATEGORY | Partition | COUNT | Percentage |
|---|---|---|---|
| Train_total | Not screened | 98442 | 97.31% |
| | Screened negative | 2503 | 2.47% |
| | Screened positive | 220 | 0.22% |
| | Total | 101165 | 100% |
| Train_Auto | Not screened | 39154 | 97.52 |
| | Screened negative | 895 | 2.23% |
| | Screened positive | 101 | 0.25% |
| | Total | 40150 | 100% |
| Train_Home | Not screened | 59289 | 97.17% |
| | Screened negative | 1608 | 2.64% |
| | Screened positive | 119 | 0.19% |
| | Total | 61015 | 100% |

### Tuning the Machine Learning Model—Model Tuning Engine 156

Referring now to FIG. 5, there is illustrated an exemplary process 500, which may be implemented by the model system 102 of FIGS. 1 and 2 and associated computing components (e.g. model tuning engine 156 and/or feature importance engine 160 and/or unsupervised machine learning model 158). The model system 102 may, in one or more aspects, be configured to execute computerized instructions to tune the model once trained (e.g. as per FIG. 4). As will be described, the model system 102 is configured to use any limited labelled data (e.g. ground truth) not for training but for evaluation of the model, such as tuning the model in the tuning phase and then causing the model, such as the isolation forest model 403 previously trained, to be retrained in a subsequent iteration by adjusting the model features and responsive to the model system 102, and particularly the model tuning engine 156 detecting differences during the tuning phase on the trained isolation forest model 403 when comparing the output of the trained model to the labelled data sets in the tuning data 407 (e.g. if an output anomaly 502 detected does not match expected labelled data in the tuning data 407).

Put another way, the model tuning engine 156 is configured to perform hyper-parameter tuning several times during model development, with different sets of features fed to the model, to ensure optimal performance. Hyper-parameter tuning is done on the screened subset of the model input data 103 (or put differently, on the labelled portion of the model input data set which forms the tuning data 407), and the top defined percentage of precision is used to select the best set of hyper-parameters. Table 2 illustrates an example set of model hyperparameters.

TABLE 2
Model Hyperparameters

| | | Value |
|---|---|---|
| Parameter | Description | Used |
| tree_number | Number of isolation trees in the | 500 |
| | model | |
| sample_number | Number of samples used to train | 8192 |
| | each isolation tree | |
| auto_samples | Ratio of auto-insurance samples | 0.6 |
| | used during training | |

Conveniently, this enables efficient and automated detection of fraudulent activity in policies while adapting to evolving patterns, enhancing the system's ability to mitigate data security risks associated with fraudulent policies in distributed environments, and compensating for limitations in the data being analyzed as well as the inaccurate manual labelling in the initial data.

### Feature Importance Engine 160

Additionally and referring to FIGS. 1-5, in one or more aspects, the model system 102 may trigger a feature importance engine 160 to provide an explainability module such as DIFFI 504 to determine which are top contributing features to each prediction and whether they are contributing positively or negatively to the anomaly 502 prediction and thereby fraud detection and responsive to this whether the feature set should be adjusted by the model system 102 in subsequent iterations of training and tuning the model 403.

As noted earlier, and with reference to FIGS. 1-5, candidate features for the isolation forest model 403 are gathered by the model system 102 from various data sources and are preprocessed. In at least some aspects, they may be divided into tabular features 105 and graph features 107. For assigning scores 506 to the features, the model system 102 and more specifically, the feature importance engine 160 applies DIFFI 504.

DIFFI 504 is a model-specific explainability method applied to the isolation forest model 403, and outperforms its model-agnostic counterparts such as SHAP in terms of explainability on isolation forest models. DIFFI 504 is formulated based on the following assumption that a split is deemed important if: (a) it separates anomalous data points at small depths, and relegates regular data points to bottom end of the tree; and (b) it induces higher imbalance among anomalous data points while being almost useless for regular ones.

DIFFI 504 consists of three main components:

(1) Induced Imbalance Coefficient (IIC) 504A: IIC assigns higher scores to the nodes that produce higher imbalance among the data points, and is defined as:

$$λ ( v ) \approx \frac{max ( {n}_{l} ( v ) , {n}_{r} ( v ) )}{n ( v )}$$

Where n(v) is the number of data points associated to the node v, and nₗ(v), nᵣ(v) are the number of points associated to its left child and right child. This assigns a higher number to the nodes that produce higher data imbalance, and lower numbers to the ones that keep the splits balanced. DIFFI 504 calculates two separate IIC scores λ_{O}(v), λ_{I}(v) for anamolous and regular points.

(2) Cumulative Feature Importance (CFI) 504B: CFI is defined for every feature and is calculated by going through every tree t, every node v, and every data point x. If a feature f is used for splitting at node v, then increase the corresponding CFI by:

$$C F I ( f ) + = \frac{1}{{h}_{t} ( x )} λ ( v )$$

In the above, the right term 1/hₜ(x) works toward the first assumption, encouraging small depths for outliers; and the second term, the pre-calculated IIC 504A, supports the second assumption, higher imbalance among outliers. Similar to IIC 504A, CFI 504B is generated for both inliers and outliers.

(3) Global Feature importance (GFI) 504C: As discussed earlier, the isolation forest model 403 randomly picks a feature for every split, and hence, the number of times a feature appears in the trees can vary. As the calculation of CFI 504B is directly affected by this, GFI 504C introduces C(f), the number of summations used for generating CFI(f). GFI 504C is the final output of DIFFI 504, and is calculated as:

$$G F I ( f ) = \frac{\frac{C F {I}_{O} ( f )}{{C}_{O} ( f )}}{\frac{C F {I}_{I} ( f )}{{C}_{I} ( f )}}$$

The above encourages features that induce low depth for outliers, and higher depth for inliers. It also discourages imbalance among inliers compared to the outliers, since a feature that separates inliers at an early stage is not ideal.

Local Feature importance (LFI) 504D: GFI 504C interprets feature contributions from a global scale, but it does not explain the contribution of specific sample features to its model score. For the interpretation of individual predictions produced by isolation forest, a similar procedure is followed focusing only on the local sample to calculate LFI 504D:

$$L F I ( x ) = \frac{C F I ( x )}{c ( x )}$$

Where CFI(x) is updated by:

$$C F I ( x ) + = \frac{1}{{h}_{t} ( x )} - \frac{1}{{h}_{m}}$$

With the last term being a correction term to factor in the non-zero contributions of a useless split.

DIFFI 504 is model specific and performs well with isolation forest model 403 to interpret isolation forest models, fully utilizing the model structure and offering direct insights.

Referring again to the operations 500 of FIG. 5, model features may be selected by the model system 102 using a DIFFI-value (GFI) based filtering approach. An isolation forest model 403 run with all features is conducted on the training data 401 set, and DIFFI values of each feature, measuring the contribution to the model's splitting and isolation of anomalous cases, is computed and ranked by the model system 102 and specifically the feature importance engine 160. The feature importance engine 160 may predefine threshold DIFFI values, remove all features with DIFFI values below the defined threshold, and trigger the model training engine 154 to re-run model training, and select the threshold value that provides the best model performance in the labelled subset of the model input 103 dataset (e.g. the model tuning data 407), which may be in one example 0.5. Thus, the model system 102 may be configured, via the feature importance engine 160 to select all features with DIFFI value above this threshold are selected to be in the final feature list for the isolation forest model 403. In subsequent model iterations and refinements performed by the model system 102, as new features are suggested as well as new insights on old features are received, the selected feature set may be adjusted by the model system 102 in adding/removing features one-by-one and comparing the performance change on the labelled tuning data 407 set formed as a subset of the model input data.

In one or more aspects, the local feature importance 504D and other DIFFI values help end users, to understand interpret the model scores (e.g. output prediction 405) on specific samples. Such DIFF values may be rendered on a display of the user interface 130 and/or relayed to other terminals shown in FIG. 1 (e.g. underwriting terminal 104) for display as UI components on screen elements for understandability of the model score generated by the isolation forest model 403. In one or more aspects, for each inference output, LFI 504D and/or DIFFI scores is calculated for all its features, and the top contributing features were included in the inference output file and distributed to one or more computing devices of the environment 100 via communication units 126 and rendered on associated user interfaces as interactive screen elements to assist users of the model system 102 better understand the prediction output provided by the model 403, as well as discovering insights for further analysis.

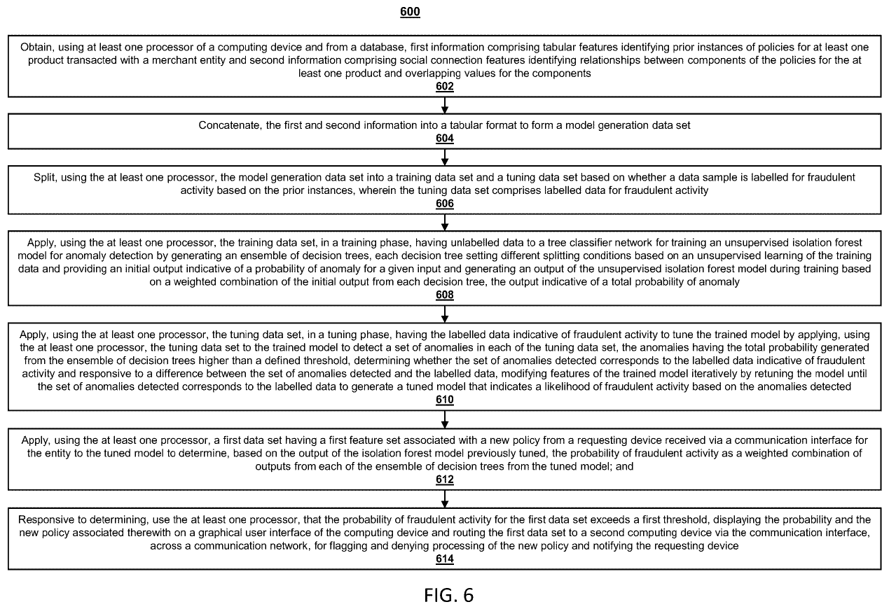

FIG. 6 is a diagram of an example flow chart of operations 600. In some implementations, one or more process blocks of FIG. 6 may be performed by the model system 102 and associated components of FIG. 2 for intelligently and dynamically identifying a likelihood of potential fraudulent activity in transactions such as online policies using an unsupervised machine learning isolation forest model, such policies and related information communicated across a communication environment 100 of FIG. 1 and notifying associated computing devices for subsequent action of the likelihood of fraudulent activity predicted, such as denying transactions and/or rendering a display of the likelihood along with one or more explainability metrics for generating the likelihood. The operations 600 are further described below with reference to FIGS. 1-5.

The computing device for carrying out the operations 600, such as the model system 102, may comprise at least one processor 122 configured to communicate with a display to provide a graphical user interface GUI where the computing device receives various features of policy data (e.g. tabular data, social connection data, historical underwriting data, etc.), such as via a communication network and across a communication interface and wherein instructions (stored in a non transient storage device), when executed by the processor configure the computing device to perform operations such as operations 600.

In at least some aspects of the operation 600, the unsupervised machine learning model 158 (e.g. the isolation forest module 403) is generated via a cooperation of the model data generation engine 152 (to generate the claim data for the model to ingest), the model training engine 154, the model tuning engine 156 and, in some aspects, the feature importance engine 160 to generate the unsupervised machine learning model 158 to provide anomaly 502 predictions and then be specifically configured via the iterative training phase (using at least unlabelled model data) and tuning phase (using the labelled model data) described herein to provide a specifically configured isolation forest model 403 for providing fraudulent activity predictions in the new claims and notifying associated entities of such predictions via an actions engine 162.

In operation 602, the processor receives from a database, first information having tabular features identifying prior instances of policies for at least one product transacted with a merchant entity and second information providing social connection features identifying relationships between components of the policies for the at least one product and overlapping values for the components.

Data fed into the model may include but is not limited to policy purchases (e.g. policy number, name, credit card); client information at onset policy purchase with a merchant (e.g. insurance policy); relationship information between multiple policies and policy holders; etc.

The social connection features may be derived by the processor constructing a social network graph 303 that graphically illustrates connection between social entities in the policy information retrieved across the computing environment 100 of FIG. 1 (emails, phone, address, policy numbers and how they connect to each other) via nodes and edges connecting the nodes.

In operation 604, the at least one processor 122 concatenates, the first and second information into a tabular format to form a model generation data set (e.g. model input data 103), such as by way of merging or combining rows from both tables based on common column or set of columns. By having the data in one unified format, this allows the concatenation of the data for ingestion by the model. For example, such input data which may be used by the at least one processor 122 for the isolation forest model 403, meaning it is structured as rows and column whereby each row may represent an observation, and each column may represent a feature or attribute of that observation.

In operation 606, the at least one processor 122 may partition, split or otherwise assign the model generation data set (e.g. the model input data 103) into a training data 401 set and a tuning data 407 set based on whether each data sample is labelled for fraudulent activity based on the prior instances. Preferably, the partitioning assigns all of the labelled data to the tuning data set for evaluating the model for determining fraudulent activity. As noted earlier, since the isolation forest model 403 is an unsupervised machine learning model 158, it does not require any labelled data during training of the model, instead during the training phase described below the model learns patterns inherent in the data to identify anomalies, thus the labelled historical policy data is assigned, by the processor to the tuning data 407. The unsupervised machine learning model 158 as described herein is configured, in one or more aspects, to isolate anomalies in the dataset based on their distinctiveness rather than being trained on specific anomaly examples.

In operation 608, the at least one processor 122 applies the training data 401 set in a training phase having unlabelled data to a tree classifier network for training an unsupervised isolation forest model 403 for anomaly detection by generating an ensemble of decision trees (e.g. iTrees 403A-403C), each decision tree setting different splitting conditions based on an unsupervised learning of the training data 401 and providing an initial output indicative of a probability of anomaly for a given input, and generating a resultant output of the unsupervised isolation forest model 403 during training based on a weighted combination of the initial output from each decision tree (e.g. see weighted ensemble of scores 402 in FIG. 4), the output indicative of a total probability of anomaly 405 in the input data. In some aspects, the processor 122 may be configured to obtain the anomaly score for a data point by averaging the anomaly scores from each of the decision trees in the isolation forest model 403. For each data point of training data, the at least one processor 122 may apply the isolation forest model 403 to compute an anomlay score based on the average path length to isolate the point across all decision trees, whereby the anomaly score may represent the degree of abnormality of the data point and low scores may indicate a higher likelihood or probability of being an anomaly. In some aspects, the processor may apply a threshold to determine which data points are considered anomalies. For example, in some aspects, the at least one processor 122 triggers the isolation forest model 403 to output a binary indicator of whether anomalies are marked as 1 (or True) and normal data points as 0 (or False).

In operation 610, the at least one processor 122 applies the tuning data 407 set in a tuning phase (e.g. see FIG. 5) to evaluate the model, the tuning data 407 having the labelled data indicative of prior instances of fraudulent activity in policy data to tune the trained model (e.g. the isolation forest model 403). The tuned model is generated to indicate a likelihood of fraudulent activity based on the anomalies detected. In at least some aspects, the identified anomalies from the isolation forest model 403 have a total probability generated from the ensemble of decision trees higher than a pre-set threshold. In at least some aspects, the at least one processor 122 determines whether the set of identified anomalies detected corresponds to the labelled data (e.g. in the tuning data 407) indicative of fraudulent activity and responsive to a difference between the set of anomalies detected and the labelled data, the at least one processor 122 iteratively modifies features (e.g. removes one feature at a time for consideration of other features) of the trained isolation forest model 403 by retuning the model repeatedly until the set of anomalies detected minimizes the difference to the labelled data to generate a tuned isolation forest model 403 that indicates a likelihood of fraudulent activity based on the anomalies detected.

Put another way, the at least one processor 122 generates the isolation forest model 403 in the training stage by randomly splitting the data space using randomly selected attributes and randomly selected split point. The at least one processor 122 may then be configured in the tuning stage, to review whether the ensemble of trees (e.g. 403A-403C) segregates the anomalies correctly and whether it can detect the anomalies using a small set of available labelled data (e.g. low volume) and the at least one processor 122 is then configured to compare the top anomalies provided in the isolation forest model 403 generated as compared to the tuning data 407 that is labelled. Thus in at least some aspects, the at least one processor 122 performs subsequent iteration of generating the isolation forest model 403 and comparing the output to the small subset of positive/negatives known in the tuning data 407 and then retunes the features of the isolation forest model 403 iteratively.

Put another way, in one or more aspects, the at least one processor 122 may be configured to compare the top anomalies to the small subset of known labelled data in the model tuning stage, e.g. small subset of positive or negative knowns (small set of known data assigned to the tuning data 407). If a discrepancy exists, in one or more aspects, the at least one processor 122 may be configured to revise the isolation forest model 403 features (e.g. update features to other unconsidered features or remove non meaningful features) and repeat this process of model regeneration and testing until what the isolation forest model 403 detects is largely aligned with the desired known output in the small set of tuning data.

For example, in at least some implementations, if the at least one processor 122 determines, that the initially trained isolation forest model 403 is not performing well, e.g. the top anomaly may not be classifying correctly then the at least one processor 122 determines that the features used to generate the model are not accurate and triggers retraining and retuning of the model until the desired result may be achieved.

In operation 612, the at least one processor receives a first data set having a first feature set associated with a new online policy for the entity (e.g. a given merchant) from a requesting device 108 via a communication interface, such as a communication unit 126 is applied to the tuned isolation forest model 403 to determine the probability of fraudulent activity within the new policy. In at least some aspects, the new policy may relate to an online bind policy facilitated through a digital platform such as a website or mobile platform accessible on the requesting device 108 for purchase with an associated merchant device and transmitted to the model system 102, e.g. via detection of a new policy or polling or otherwise, such as to automate decision making processes on the policy (e.g. approve or deny via a policy server) and assessing the risk associated with the policy to be communicated to the devices associated with the policy.

In operation 614, the at least one processor 122 determines if the probability of fraudulent activity, when applied to the tuned and trained isolation forest model 403 for the first data set exceeds a first threshold. If so, the at least one processor 122 notifies and renders on a display the probability of fraudulent activity and metadata identifying the new policy associated therewith on a graphical user interface of the model system, shown as user interface 130. Additionally, the processor routes the first data set to a second computing device (e.g. a policy server 112) via the communication interface such as communication unit 126 across a communication network 106 for flagging and denying processing of the new policy and notifying the requesting device 108. Additionally or alternatively, the at least one processor 122 may communicate the flagged policy having a high probability of fraudulent activity based on applying the trained and tuned unsupervised machine learning model 158, to the underwriting terminal 104 for subsequent verification of the resulting output via the rules data set 109 or via interactive input on the user interface of the underwriting terminal 104 to confirm or deny the flagged information and to relay such information back to the model system 102 for tuning and training the model 403 in a subsequent iteration based on the updated information.

Although FIG. 6 shows example blocks of process 600, in some implementations, process 600 may include additional blocks, fewer blocks, different blocks, or differently arranged blocks than those depicted in FIG. 6. Additionally or alternatively, two or more of the blocks of process 600 may be performed in parallel.

In one or more examples, the functions described may be implemented in hardware, software, firmware, or combinations thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including such media that may facilitate transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be available media that can be accessed by one or more computers or one or more processors to retrieve instructions, code and/or data structures for implementation of the techniques described in this disclosure. A computer program product may include a computer-readable medium. By way of example, and not limitation, such computer-readable storage media can comprise RAM, ROM, EEPROM, optical disk storage, magnetic disk storage, or other magnetic storage devices, flash memory, or any other medium that can be used to store desired program code in the form of instructions or data structures and that can be accessed by a computer. In addition, any connection is properly termed a computer-readable medium. For example, if instructions are transmitted from a website, server, or other remote source using wired or wireless technologies, such are included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more general purpose microprocessors, application specific integrated circuits (ASICs), field programmable logic arrays (FPGAs), digital signal processors (DSPs), or other similar integrated or discrete logic circuitry. The term “processor,” as used herein may refer to any of the foregoing examples or any other suitable structure to implement the described techniques. In addition, in some aspects, the functionality described may be provided within dedicated software modules and/or hardware. In addition, the techniques could be fully implemented in one or more circuits or logic elements. The techniques of this disclosure may be implemented in a wide variety of devices or apparatuses, an integrated circuit (IC) or a set of ICs (e.g., a chip set).

Furthermore, the elements depicted in the flowchart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it may be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

Various embodiments have been described. These and other embodiments are within the scope of the following claims.

1. A computer implemented system comprising:
a communication interface;
a memory storing instructions;
one or more processors coupled to the communication interface and to the memory, the one or more processors configured to execute the instructions to perform operations comprising:
obtaining, from a database, first information comprising tabular features identifying prior instances of policies for at least one product transacted with a merchant entity;
obtaining, from the database, second information comprising social connection features identifying relationships between components of the policies for the at least one product and overlapping values for the components;
concatenating the first and second information into a tabular format to form a model generation data set;
splitting the model generation data set into a training data set and a tuning data set based on whether a data sample is labelled for fraudulent activity based on the prior instances, wherein the tuning data set comprises labelled data for fraudulent activity;
applying the training data set, in a training phase, having unlabelled data to a tree classifier network for training an unsupervised isolation forest model for anomaly detection by generating an ensemble of decision trees, each decision tree setting different splitting conditions based on an unsupervised learning of the training data and providing an initial output indicative of a probability of anomaly for a given input and generating an output of the unsupervised isolation forest model during training based on a weighted combination of the initial output from each decision tree, the output indicative of a total probability of anomaly;
applying the tuning data set, in a tuning phase, having the labelled data indicative of fraudulent activity to tune the trained model by applying the tuning data set to the trained model to detect a set of anomalies corresponding to the tuning data set, the anomalies having the total probability generated from the ensemble of decision trees higher than a defined threshold, determining whether the set of anomalies detected corresponds to the labelled data indicative of fraudulent activity and responsive to a difference between the set of anomalies detected and the labelled data, modifying features of the trained model iteratively by retuning the model until the set of anomalies detected corresponds to the labelled data to generate a tuned model that indicates a likelihood of fraudulent activity based on the anomalies detected;
applying a first data set having a first feature set associated with a new policy from a requesting device received via the communication interface for the entity to the tuned model to determine, based on the output of the isolation forest model previously tuned, the probability of fraudulent activity as a weighted combination of outputs from each of the ensemble of decision trees from the tuned model; and,
responsive to determining the probability of fraudulent activity for the first data set exceeds a first threshold, displaying the probability and the new policy associated therewith on a graphical user interface and routing the first data set to a second computing device via the communication interface, across a communication network, for flagging and denying processing of the new policy and notifying the requesting device.

2. The computer implemented system of claim 1 wherein the processor is further configured to perform operations, comprising:
responsive to determining the probability of fraudulent activity for the first data set is below the first threshold, displaying the probability on the graphical user interface and routing the first data set to the second computing device via the communication interface for allowing processing of the new policy and notifying the requesting device.

3. The computer implemented system of claim 1, wherein operations of the processor for retuning the model comprise:
determining a defined set of top contributing features for all input features in the model generation data set contributing to the detection of a particular anomaly not corresponding to thereby not indicative of fraudulent activity based on the labelled data in the tuning data set;
removing the set of top contributing features in the tuning data set and the training data set to bias the model to consider other features in an updated feature set; and
iteratively retraining and retuning the model based on the updated feature set indicative of fraudulent activity to generate an updated model for subsequent incoming policies.

4. The computer implemented system of claim 3 wherein operations of the processor for determining the defined set of top contributing features contributing to the detection comprises applying depth based isolation forest feature importance (DIFFI) to generate DIFFI values providing a measure of feature contribution of each feature for all the input features in the model generation data set to splitting and isolation of anomalous cases in the generated ensemble of decision trees by the unsupervised isolation forest model trained and applying the feature contribution to remove features with DIFFI values below a selected threshold and repeating iteratively training and tuning of the model based on remaining features to determine the selected threshold to provide a desired feature set having an improved correlation between anomaly detection as compared to an indication of fraudulent activity in the labelled data compared to a prior iteration of the model.

5. The computer implemented system of claim 4, wherein operations of the processor further comprise rendering the likelihood of fraudulent activity and the measure of feature contribution provided via DIFFI values for each feature of a set of input features for the new policy contributing to anomaly detection prediction, as interactive interface elements on the graphical user interface.

6. The computer implemented system of claim 4, wherein operations of the processor further comprise receiving additional features or updated features for the model generation data set in a subsequent model iteration and removing features one at a time in each iteration of model training and model tuning to compare performance change as compared to the labelled data during the tuning phase to determine an optimal set of features for generating the unsupervised isolation forest model.

7. The computer implemented system of claim 5, wherein operations of the processor further comprise applying a plurality of data sets for new policies associated with the merchant entity to the tuned model and determining a ranked list of each of the new policies based on the likelihood of fraudulent activity determined from the tuned model, and operations further comprise: rendering the ranked list as interactive interface elements on the graphical user interface for receiving input accepting or denying each policy and operations of the processor further configured to feed back the input to retrain and retune the isolation forest model.

8. The computer implemented system of claim 4, wherein the tuning data set comprises a set of labelled fraudulent policies interspersed with a set of labelled non-fraudulent policies.

9. The computer implemented system of claim 1, wherein the training data set comprises unlabelled fraudulent and non-fraudulent policies.

10. The computer implemented system of claim 1, wherein identifying relationships comprises operations of the processor to generate a social network graph of connectivity between components of the policies comprising policy information, policy holder information, identification information for the at least one product, and social entities along with associated values for the components, wherein graph links are connected between a set of nodes relating to a set of policies sharing a same component value.

11. A computer implemented method comprising:
obtaining, using at least one processor of a computing device and from a database, first information comprising tabular features identifying prior instances of policies for at least one product transacted with a merchant entity;
obtaining, using the at least one processor, from the database, second information comprising social connection features identifying relationships between components of the policies for the at least one product and overlapping values for the components;
concatenating, using the at least one processor, the first and second information into a tabular format to form a model generation data set;
splitting, using the at least one processor, the model generation data set into a training data set and a tuning data set based on whether a data sample is labelled for fraudulent activity based on the prior instances, wherein the tuning data set comprises labelled data for fraudulent activity;
applying, using the at least one processor, the training data set, in a training phase, having unlabelled data to a tree classifier network for training an unsupervised isolation forest model for anomaly detection by generating an ensemble of decision trees, each decision tree setting different splitting conditions based on an unsupervised learning of the training data and providing an initial output indicative of a probability of anomaly for a given input and generating an output of the unsupervised isolation forest model during training based on a weighted combination of the initial output from each decision tree, the output indicative of a total probability of anomaly;
applying, using the at least one processor, the tuning data set, in a tuning phase, having the labelled data indicative of fraudulent activity to tune the trained model by applying, using the at least one processor, the tuning data set to the trained model to detect a set of anomalies in each of the tuning data set, the anomalies having the total probability generated from the ensemble of decision trees higher than a defined threshold, determining whether the set of anomalies detected corresponds to the labelled data indicative of fraudulent activity and responsive to a difference between the set of anomalies detected and the labelled data, modifying features of the trained model iteratively by retuning the model until the set of anomalies detected corresponds to the labelled data to generate a tuned model that indicates a likelihood of fraudulent activity based on the anomalies detected;
applying, using the at least one processor, a first data set having a first feature set associated with a new policy from a requesting device received via a communication interface for the entity to the tuned model to determine, based on the output of the isolation forest model previously tuned, the probability of fraudulent activity as a weighted combination of outputs from each of the ensemble of decision trees from the tuned model; and,
responsive to determining, using the at least one processor, the probability of fraudulent activity for the first data set exceeds a first threshold, displaying the probability and the new policy associated therewith on a graphical user interface of the computing device and routing the first data set to a second computing device via the communication interface, across a communication network, for flagging and denying processing of the new policy and notifying the requesting device.

12. The computer implemented method of claim 11 further comprising:
responsive to determining the probability of fraudulent activity for the first data set is below the first threshold, displaying the probability on the graphical user interface and routing the first data set to the second computing device via the communication interface for allowing processing of the new policy and notifying the requesting device.

13. The computer implemented method of claim 11 further comprising:
determining a defined set of top contributing features for all input features in the model generation data set contributing to the detection of a particular anomaly not corresponding to thereby not indicative of fraudulent activity based on the labelled data in the tuning data set;
removing the set of top contributing features in the tuning data set and the training data set to bias the model to consider other features in an updated feature set; and
iteratively retraining and retuning the model based on the updated feature set indicative of fraudulent activity to generate an updated model for subsequent incoming policies.

14. The computer implemented method of claim 13 wherein determining the defined set of top contributing features contributing to the detection comprises applying depth based isolation forest feature importance (DIFFI) to generate DIFFI values providing a measure of feature contribution of each feature for all the input features in the model generation data set to splitting and isolation of anomalous cases in the generated ensemble of decision trees by the unsupervised isolation forest model trained and applying the feature contribution to remove features with DIFFI values below a selected threshold and repeating iteratively training and tuning of the model based on remaining features to determine the selected threshold to provide a desired feature set having an improved correlation between anomaly detection as compared to an indication of fraudulent activity in the labelled data compared to a prior iteration of the model.

15. The computer implemented method of claim 14, further comprising: rendering the likelihood of fraudulent activity and the measure of feature contribution provided via DIFFI values for each feature of a set of input features for the new policy contributing to anomaly detection prediction, as interactive interface elements on the graphical user interface of the computing device.

16. The computer implemented method of claim 14, further comprising receiving additional features or updated features for the model generation data set in a subsequent model iteration and removing features one at a time in each iteration of model training and model tuning to compare performance change as compared to the labelled data during the tuning phase to determine an optimal set of features for generating the unsupervised isolation forest model.

17. The computer implemented method of claim 15, further comprising applying a plurality of data sets for new policies associated with the merchant entity to the tuned model and determining a ranked list of each of the new policies based on the likelihood of fraudulent activity determined from the tuned model, and further rendering the ranked list as interactive interface elements on the graphical user interface for receiving input accepting or denying each policy to feed back the input to retrain and retune the isolation forest model.

18. The computer implemented method of claim 14, wherein the tuning data set comprises a set of labelled fraudulent policies interspersed with a set of labelled non-fraudulent policies.

19. The computer implemented method of claim 11, wherein the training data set comprises unlabelled fraudulent and non-fraudulent policies.

20. The computer implemented method of claim 11, wherein identifying relationships comprises generating a social network graph of connectivity between components of the policies comprising policy information, policy holder information, identification information for the at least one product, and social entities along with associated values for the components, wherein graph links are connected between a set of nodes relating to a set of policies sharing a same component value.

21. A non-transitory computer readable medium having instructions tangibly stored thereon, wherein the instructions, when executed by one or more processors cause the one or more processors to:
obtain, from a database, first information comprising tabular features identifying prior instances of policies for at least one product transacted with a merchant entity;
obtain, from the database, second information comprising social connection features identifying relationships between components of the policies for the at least one product and overlapping values for the components;
concatenate the first and second information into a tabular format to form a model generation data set;
split the model generation data set into a training data set and a tuning data set based on whether a data sample is labelled for fraudulent activity based on the prior instances, wherein the tuning data set comprises labelled data for fraudulent activity;
apply the training data set, in a training phase, having unlabelled data to a tree classifier network for training an unsupervised isolation forest model for anomaly detection by generating an ensemble of decision trees, each decision tree setting different splitting conditions based on an unsupervised learning of the training data and providing an initial output indicative of a probability of anomaly for a given input and generating an output of the unsupervised isolation forest model during training based on a weighted combination of the initial output from each decision tree, the output indicative of a total probability of anomaly;
apply the tuning data set, in a tuning phase, having the labelled data indicative of fraudulent activity to tune the trained model by applying the tuning data set to the trained model to detect a set of anomalies in each of the tuning data set, the anomalies having the total probability generated from the ensemble of decision trees higher than a defined threshold, determining whether the set of anomalies detected corresponds to the labelled data indicative of fraudulent activity and responsive to a difference between the set of anomalies detected and the labelled data, modifying features of the trained model iteratively by retuning the model until the set of anomalies detected corresponds to the labelled data to generate a tuned model that indicates a likelihood of fraudulent activity based on the anomalies detected;
apply a first data set having a first feature set associated with a new policy from a requesting device received via a communication interface for the entity to the tuned model to determine, based on the output of the isolation forest model previously tuned, the probability of fraudulent activity as a weighted combination of outputs from each of the ensemble of decision trees from the tuned model; and,
responsive to determining the probability of fraudulent activity for the first data set exceeds a first threshold, display the probability on a graphical user interface and the new policy associated therewith and routing the first data set to a second computing device via the communication interface, across a communication network, for flagging and denying processing of the new policy and notifying the requesting device.
